(19) United States
(12) Patent Application Publication
(10) Pub. No.: US 2019/0293801 A1
(43) Pub. Date: Sep. 26, 2019

(54) GPS tracking system for newborn infant

(71) Applicant: Gary Kelley, Mount Nebo, WV (US)

(72) Inventor: Gary Kelley, Mount Nebo, WV (US)

(21) Appl. No.: 15/927,399

(22) Filed: Mar. 21, 2018

(51) Int. Cl. G01S 19/01; G01C 21/20

(52) U.S. Cl. CPC G01S 19/01; G08B 21/0288; G01C 21/20

(57) ABSTRACT

The invention is directed to a GPS tracking system for a newborn infant. The system is comprised of a clip to be worn on the umbilical cord, which provides a Global Positioning System (GPS) device. The system is further comprised of a mobile application which may be installed on the user's smartphone or other electronic device. The user may remotely activate the GPS device in the clip by using the application. When activated, the device periodically transmits a GPS query, acquires the location information of the clip, and transmits the information to the user's electronic device and to one or more secured servers. Local emergency service agencies such as law enforcement agencies are provided passwords, enabling them to instantly access the servers when a newborn infant is reported missing and acquire current location information.

### CROSS-REFERENCE TO RELATED APPLICATIONS

This application relates back to, and claims the priority of Provisional Patent Application No. 62/479,273 filed on Mar. 30, 2017.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to Global Positioning System (GPS) tracking systems, and in particular to a GPS tracking system affixed to an umbilical cord for the purpose of tracking a newborn infant wearing it when lost. New parents are often worried about their newborn infants being abducted or becoming lost.

A search of the prior art reveals various devices which have been developed to provide the features of a GPS tracking device, which may be used inconspicuously, quickly, and easily with a newborn infant. None are closely related to the present invention, but several include features which resemble those of the present invention. Each has proven to be less than satisfactory for the present purpose in its own way.

GPS relative position detection system, U.S. Pat. No. 5,689,269 (priority Jan. 25, 1995), provides a system of devices both capable of receiving civilian GPS signals, but also capable of providing a relative distance and direction indication that is accurate to several meters. A first device would be capable of transmitting its GPS determined position to a second device. The second device would include a means for receiving the GPS determined position of the first device, and would also include means for calculating the relative distance and direction between the first and second devices. The system would further include the ability of the first device to selectively transmit telemetry at a desired frequency. By providing the second device with the ability to selectively tune a receiver to receive a telemetry signal broadcast by different devices, a distance and direction to a plurality of first devices is possible.

GPS children locator, U.S. Patent Appl. No. 2004/0198382 (priority Oct. 15, 2002), provides a locator device carried on or by a person, particularly a child, sends out a signal using satellite technology known as GPS—Global Positioning System. Once the child is wearing the GPS locator device, the parent, guardian, or care giver, logs onto a computer, or a cellular phone or other communication equipment with a GPS feature, and a Web page map reveals the child's location to within a few feet. The locator device also has a built-in personal identification chip in which a child's personal information is recorded. The locator device is configured as a tiny article that can be easily attached to the child's clothing and may be camouflaged in various ways so as to avoid suspicion by a kidnapper that the article contains a GPS locator device. Alternative attachment arrangements enable the user to select the optimum attachment arrangement for the type and nature of the material upon which it is to be affixed.

GPS device and portal, U.S. Patent Appl. No. 2011/0148626 (priority Jan. 12, 2009), provides a portable GPS device and portal for communicating with the GPS device and methods of use thereof are described. A method of tracking movement of a portable GPS device using a geofence comprises: initializing a geofence, the geofence specifying a geographic boundary; storing parameters of the geofence in a portable GPS device; sending a notification message from the portable GPS device to a remote location in response to the portable GPS device determining that it has crossed the boundary.

Location tracking system, U.S. Patent Appl. No. 2008/0062120 (priority Sep. 11, 2006), provides a multi-range location tracking system for tracking the location of one or more objects, such as people, pets, or things. The system has one or more GPS-enabled accessory devices, with each accessory device being coupled to a corresponding one of the objects and being configured to generate location data of the corresponding object. The location tracking system also has a wireless link and one or more base units configured to communicate location data directly with the one or more accessory devices through the wireless link.

Method and apparatus for locating missing persons, U.S. Patent Appl. No. 2003/0151506 (priority Feb. 11, 2002), provides a system for locating a person including a mobile transmitter removably secured to the person and a portable monitoring unit carried by a user monitoring the location of the person. The mobile transmitter receives GPS ranging signals from GPS satellites. Each of the GPS ranging signals includes an offset proportional to the distance of the mobile transmitter from the respective GPS satellite broadcasting the GPS ranging signal. The GPS ranging signals, including the respective offsets, are transmitted to the portable monitoring unit. The portable monitoring unit comprises a GPS circuit which determines the location of the mobile transmitter based on the GPS ranging signals received by the mobile transmitter, and superimposes the location of the mobile transmitter on a map displayed on the portable monitoring unit.

Portable position detector and position management system, U.S. Pat. No. 6,132,391 (priority Dec. 30, 1997), provides a portable position detector and a position management system that are capable of accurately detecting the direction of a walking body even when GPS signals cannot be received (or without reception) and thereby enhancing the accuracy of the dead reckoned position of the walking body. The portable position detector is equipped with a pedometer and a geomagnetic sensor. With the pedometer, the moved distance of a walker is detected by a calculation of the number of steps times the length of a step. The moved direction is detected with the geomagnetic sensor. With this, the moved position of the walker is accurately detected by the self-contained navigation system. Particularly, even in the case where the position detector is located in a forest or between buildings, where a signal cannot be received from a global positioning system (GPS) due to high buildings, banks, and forests, the position detector with a portable size and weight applicable to a walker can know with a practically sufficient degree of accuracy the position of a person carrying this portable detector by the self-contained navigation system.

A device that enables Global Positioning System (GPS) tracking that is easily affixed to the umbilical cord will enable the user to discreetly track a newborn infant who is at risk for becoming lost or abducted, and will provide peace of mind for the parents. A GPS tracking system for a newborn infant, enabling a user to remotely activate a GPS device in a device worn on the umbilical cord of a newborn infant and obtain location information from it, would resolve this problem.

### SUMMARY OF THE INVENTION

Accordingly, the invention is directed to a GPS tracking system for a newborn infant. The system is comprised of a clip to be worn on the umbilical cord, which provides a Global Positioning System (GPS) device. The system is further comprised of a mobile application which may be installed on the user's smartphone or other electronic device. The user may remotely activate the GPS device in the clip by using the application. When activated, the device periodically transmits a GPS query, acquires the location information of the clip, and transmits the information to the user's electronic device and to one or more secured servers. Local emergency service agencies such as law enforcement agencies are provided passwords, enabling them to instantly access the servers when a newborn infant is reported missing and acquire current location information.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a top perspective view of the first exemplary embodiment, displaying the clip 10, the hinge 11, the jaws 12, and the latch 13.

FIG. 2 is a front view of the first exemplary embodiment, displaying the clip 10, the hinge 11, the jaws 12, and the latch 13.

FIG. 3 is a side perspective view of the first exemplary embodiment, displaying the clip 10, the hinge 11, the jaws 12, and the latch 13.

FIG. 4 is a front view of the first exemplary embodiment in the opened position, displaying the clip 10, the hinge 11, the jaws 12, the latch 13, and the tongue 14.

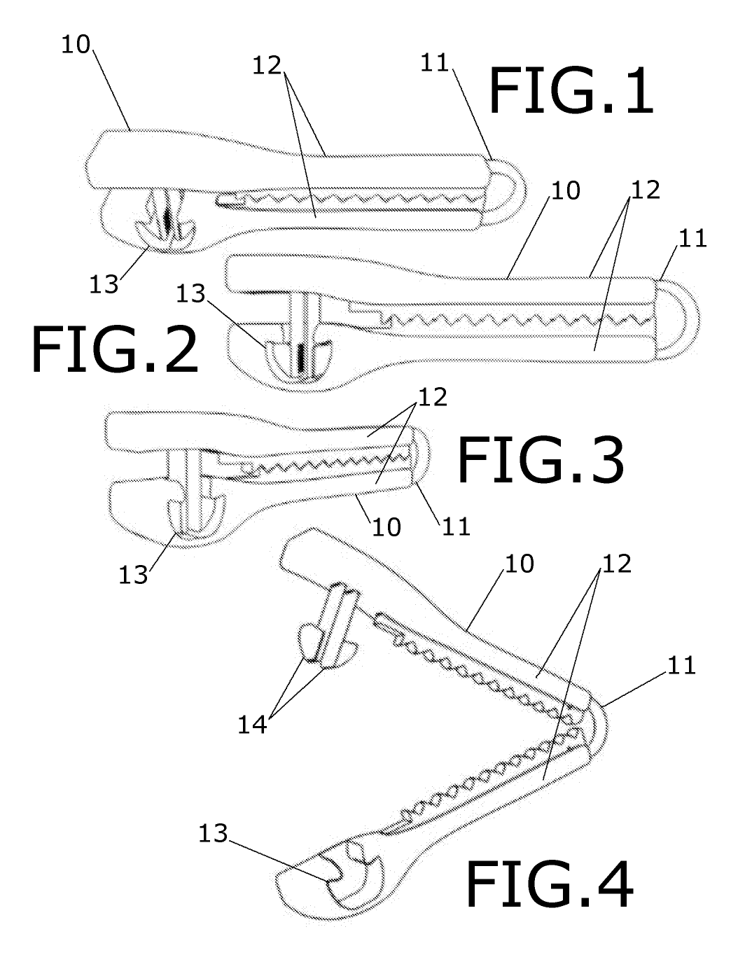

### DETAILED DESCRIPTION OF THE INVENTION

Referring now to the invention in more detail, the invention is a GPS tracking system for a newborn infant.

It is to be understood that while the invention is intended for use with a newborn infant who is at risk of becoming lost or being abducted, and principally for use by the newborn nursery staff of a hospital or similar facility, this is not intended as a limitation. With suitable modifications or with no modifications at all, the invention may be used by any adult user with an older child, an elderly or disabled adult, a pet, livestock, or an object which is at risk of becoming lost or stolen.

The first exemplary embodiment is comprised of a clip 10 to be affixed to the umbilical cord of a newborn infant, which provides a simple, flexible hinge 11 and two serrated jaws 12. The clip 10 provides an internal, battery-powered GPS device and is affixed by closing the jaws 12 around the umbilical cord a short distance from the end of the umbilical cord. The clip is fastened by a latch 13, which engages a pair of back-to-back J-shaped tongues 14, configured such that together, the two tongues 14 comprise a T-shape. When inserted downward into the latch 13, the tongues 14 flex inward toward each other. The clip 10 may be removed by twisting the flexible hinge 11 such that the tongues 14 laterally slide out the front of the latch 13. This comprises a simple, inexpensive fastener which is well known to the art.

The system is further comprised of a mobile application which may be installed on the adult user's smartphone or other electronic device. The adult user may remotely activate a GPS location sequence in the GPS device of the clip 10 by using the application. When activated, the GPS device transmits a GPS query, acquires the location information of the clip 10, and transmits the location information to the adult user's electronic device and one or more secured servers. The GPS device is factory programmed with a unique serial number which is paired with any acquired location information, such that users may easily distinguish the location information from other data which may be stored on the servers.

The electronic components in the clip 10 are powered by a battery pack and may either be constantly active, activated by remote signal by its owner or emergency services, activated by motion sensor, activated by a third party security data service, or activated by some other method to locate a newborn infant known to be missing. Once the GPS location sequence is activated, the GPS device acquires and transmits location information to the user, to emergency service agencies, to the secured servers, or to some combination thereof pursuant to configuration, using existing wireless data communications networks such as a cellular telephone data network.

The GPS device and the battery pack are water resistant. All components of the clip 10 are designed to be easily and inexpensively manufactured, such that the clip 10 is expendable and easily replaced. The electronic components of the GPS device preferably include a memory device, a microprocessor, an internal ring antenna, a transmitter, and a receiver. After being affixed to the newborn infant by hospital staff, the clip 10 and the application may continue to be used by the parents of the newborn infant for up to one month after returning home, until the umbilical cord naturally falls off from the abdomen of the newborn infant. Alternately, the clip 10 may be affixed to the diaper, clothing, or blanket of the newborn infant, or some other object in close proximity to a newborn infant which is intended to be carried with the newborn infant.

To use the first exemplary embodiment, the user may download and install the mobile application on the user's smartphone or other mobile electronic device. The user may then affix the clip 10 to the umbilical cord of the newborn infant.

The jaws 12, the latch 13, the GPS device, and the battery pack are preferably manufactured from rigid, durable materials, such as steel, aluminum alloy, copper alloy, and plastic. The hinge 11 and the tongues 14 are is preferably manufactured from a flexible, durable material such as plastic or silicone.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A Global Positioning System (GPS) tracking system for a newborn infant, comprised of a clip to be affixed to the umbilical cord of a newborn infant, which provides a simple, flexible hinge and two serrated jaws.

2. The tracking system of claim 1, wherein the clip provides an internal, battery-powered GPS device and is affixed by closing the jaws around the umbilical cord a short distance from the end of the umbilical cord.

3. The tracking system of claim 1, wherein the clip is fastened by a latch, which engages a pair of back-to-back J-shaped tongues, configured such that together, the two tongues comprise a T-shape.

4. The tracking system of claim 1, wherein when inserted downward into the latch, the tongues flex inward toward each other.

5. The tracking system of claim 1, wherein the clip may be removed by twisting the flexible hinge such that the tongues laterally slide out the front of the latch, comprising a simple, inexpensive fastener which is well known to the art.

6. The tracking system of claim 1, wherein the system is further comprised of a mobile application which may be installed on an adult user's smartphone or other electronic device.

7. The tracking system of claim 1, wherein an adult user may remotely activate a GPS location sequence in the GPS device of the clip by using the application.

8. The tracking system of claim 1, wherein when activated, the GPS device transmits a GPS query, acquires the location information of the clip, and transmits the location information to the adult user's electronic device and one or more secured servers.

9. The tracking system of claim 1, wherein the GPS device is factory programmed with a unique serial number which is paired with any acquired location information, such that users may easily distinguish the location information from other data which may be stored on the servers.

10. The tracking system of claim 1, wherein the electronic components in the clip are powered by a battery pack and may either be constantly active, activated by remote signal by its owner or emergency services, activated by motion sensor, activated by a third party security data service, or activated by some other method to locate a newborn infant known to be missing.

11. The tracking system of claim 1, wherein once the GPS location sequence is activated, the GPS device acquires and transmits location information to the user, to emergency service agencies, to the secured servers, or to some combination thereof pursuant to configuration, using existing wireless data communications networks such as a cellular telephone data network.

12. The tracking system of claim 1, wherein the GPS device and the battery pack are water resistant, and all components of the clip are designed to be easily and inexpensively manufactured, such that the clip is expendable and easily replaced.

13. The tracking system of claim 1, wherein the electronic components of the GPS device preferably include a memory device, a microprocessor, an internal ring antenna, a transmitter, and a receiver.

14. The tracking system of claim 1, wherein after being affixed to the newborn infant by hospital staff, the clip and the application may continue to be used by the parents of the newborn infant for up to one month after returning home, until the umbilical cord naturally falls off from the abdomen of the newborn infant.

15. The tracking system of claim 1, wherein alternately, the clip may be affixed to the diaper, clothing, or blanket of the newborn infant, or some other object in close proximity to a newborn infant which is intended to be carried with the newborn infant.

16. The tracking system of claim 1, wherein the user may download and install the mobile application on the user's smartphone or other mobile electronic device, then affix the clip to the umbilical cord of the newborn infant.
